(19) United States
(12) Patent Application Publication
(10) Pub. No.: US 2015/0244030 A1
(43) Pub. Date: Aug. 27, 2015

(54) LITHIUM ION SECONDARY BATTERY AND ELECTROLYTE SOLUTION THEREOF

(71) Applicant: Ningde Amperex Technology Ltd., Ningde (CN)

(72) Inventors: Shite YE, Ningde (CN); Chenghua FU, Ningde (CN); Chunbo CHU, Ningde (CN); Azhong WANG, Ningde (CN)

(73) Assignee: Ningde Amperex Technology Ltd., Ningde (CN)

(21) Appl. No.: 14/289,248

(22) Filed: May 28, 2014

(30) Foreign Application Priority Data
Feb. 21, 2014 (CN) 201410059585.4

(51) Int. Cl. H01M 10/0569; H01M 10/0525

(52) U.S. Cl. CPC H01M 10/0569; H01M 10/0525

(57) ABSTRACT

The present disclosure provides a lithium ion secondary battery and electrolyte solution thereof. The electrolyte solution of the lithium ion secondary battery includes a nonaqueous organic solvent, and a lithium salt dissolved in the nonaqueous organic solvent. The nonaqueous organic solvent includes a dicyano ester compound of a structure shown by Formula I, Formula II, or Formula III. Formula I represents dicyano carbonate ester compounds, Formula II represents dicyano sulfite ester compounds, Formula III represents dicyano sulfate ester compounds, and the value n is an integer between 1 and 4. The lithium ion secondary battery according to the present disclosure includes the aforementioned electrolyte solution. At a working voltage of 4.3 V or higher, the lithium ion secondary battery according to the present disclosure can effectively suppress the oxidation of the electrolyte solution and improve the storage performance of the lithium ion secondary battery at high temperature.

### CROSS-REFERENCE TO RELATED APPLICATION(S)

This application claims the benefit of Chinese Patent Application No. CN201410059585.4, entitled “LITHIUM ION SECONDARY BATTERY AND ELECTROLYTE SOLUTION THEREOF” and filed on Feb. 21, 2014 in the State Intellectual Property Office of the People's Republic of China (PRC) (SIPO), the disclosure of which is expressly incorporated by reference herein in its entirety.

### BACKGROUND

1. Field

The present disclosure relates generally to the field of batteries, and more particularly, to a lithium ion secondary battery and electrolyte solution thereof.

2. Background

Over recent years, requirements for mobile electronic products have increased, and as a result, research on lithium ion secondary batteries with high power and high energy density has increased.

When fully charged, the entire chemical system of a lithium ion secondary battery has extremely high chemical activity. When an electronic product is used continuously or when the environmental temperature increases, it is possible to put the lithium ion secondary battery in a high temperature state. When a lithium ion secondary battery is in a high temperature state, metal oxides as the positive electrode active material show very strong oxidizing properties. Such metal oxides tend to undergo an oxidation reaction with the electrolyte solution, leading to the decomposition of the electrolyte solution. As the voltage of the lithium ion secondary battery becomes higher, moreover, the oxidized decomposition of the electrolyte solution on the surface of the positive plate (positive electrode) intensifies, leading to a weakened storage performance of the lithium ion secondary battery. Therefore, a key to preventing deterioration of the high temperature storage performance of a lithium ion secondary battery is to suppress the oxidation reaction between the electrolyte solution and the positive electrode active material.

To increase the energy density of a lithium ion secondary battery, positive electrode active materials with a relatively high nickel element content, such as lithium nickel cobalt aluminum oxides, lithium nickel cobalt manganese oxides, etc., are primarily used. However, positive electrode active materials with high nickel element content enhances the oxidizing capability of the positive plate when the charge cutoff voltage is relatively high, leading to more serious oxidation problems of the electrolyte solution. Therefore, it is particularly urgent to solve the problem of electrolyte solution decomposition regarding this type of positive electrode active materials with high energy or when a lithium ion secondary battery is used under a high voltage.

### SUMMARY

In light of the problems of the prior art, the object of the present disclosure is to provide a lithium ion secondary battery and electrolyte solution thereof, which can effectively suppress the oxidation of the electrolyte solution and improve the high temperature storage performance of the lithium ion secondary battery at a working voltage of 4.3 V or higher, thereby solving the problems of electrolyte solution decomposition during high-voltage and high-temperature storage of a lithium ion secondary battery and the consequent gas generation in the lithium ion secondary battery.

To attain the above object, according to a first aspect of the present disclosure, the present disclosure provides an electrolyte solution of a lithium ion secondary battery including a nonaqueous organic solvent, and a lithium salt dissolved in the nonaqueous organic solvent. The nonaqueous organic solvent includes a dicyano ester compound of a structure shown by Formula I, Formula II, or Formula III:

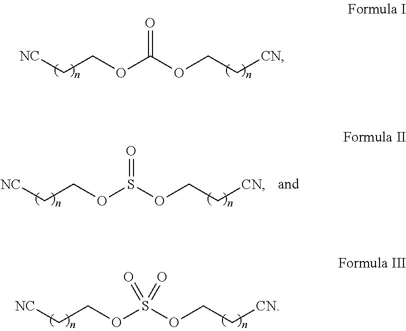

Formula I represents dicyano carbonate ester compounds, Formula II represents dicyano sulfite ester compounds, and Formula III represents dicyano sulfate ester compounds. The value n is an integer between 1 and 4 (greater than or equal to 1 and less than or equal to 4).

According to a second aspect of the present disclosure, a lithium ion secondary battery is provided that includes a positive plate (positive electrode), a negative plate (negative electrode), an isolating film disposed between the positive plate and the negative plate, and an electrolyte solution. The electrolyte solution is the electrolyte solution of a lithium ion secondary battery according to the first aspect.

The first and second aspects of the disclosure have the following advantageous effects: (1) the electrolyte solution of a lithium ion secondary battery has improved stability in the fully charged state of the battery, and (2) the added dicyano ester compounds can effectively passivate the decomposition of the electrolyte solution by the electrodes. As a result, the lithium ion secondary battery according to the present disclosure has a smaller rate of thickness expansion at high temperature and high voltage, as well as better high temperature storage performance.

### BRIEF DESCRIPTION OF THE DRAWINGS

FIG. 1 is a diagram illustrating a dicyano carbonate ester compound within a nonaqueous organic solvent of an electrolyte solution of a lithium ion secondary battery.

FIG. 2 is a diagram illustrating a dicyano sulfite ester compound within a nonaqueous organic solvent of an electrolyte solution of a lithium ion secondary battery.

FIG. 3 is a diagram illustrating a dicyano sulfate ester compound within a nonaqueous organic solvent of an electrolyte solution of a lithium ion secondary battery.

### DETAILED DESCRIPTION

The lithium ion secondary battery and electrolyte solution thereof according to the present disclosure will be described in detail below, as well as comparison examples, examples and testing results.

First, the electrolyte solution of a lithium ion secondary battery according to the first aspect of the present disclosure will be described.

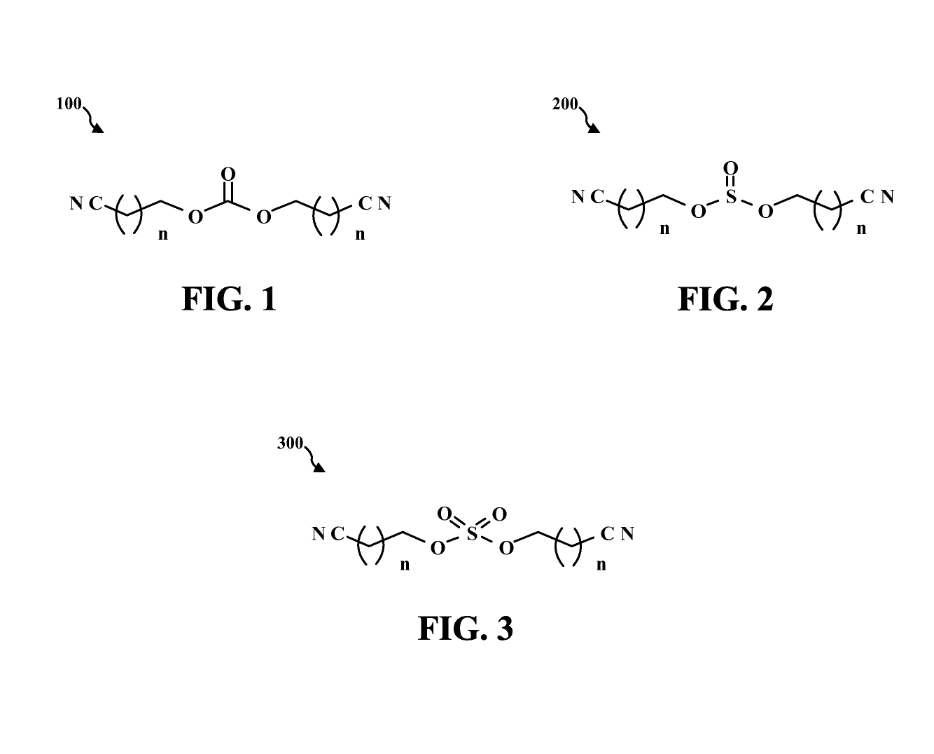

The electrolyte solution of a lithium ion secondary battery according to the first aspect of the present disclosure includes a nonaqueous organic solvent, and a lithium salt dissolved in the nonaqueous organic solvent. The nonaqueous organic solvent includes a dicyano ester compound of a structure shown by Formula I (100 of FIG. 1), Formula II (200 of FIG. 2), or Formula III (300 of FIG. 3):

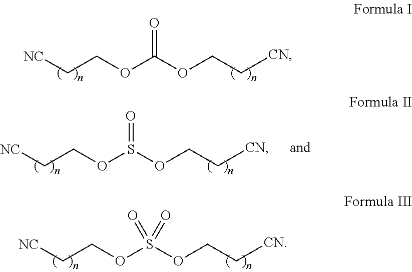

Formula I represents dicyano carbonate ester compounds, Formula II represents dicyano sulfite ester compounds, and Formula III represents dicyano sulfate ester compounds. The value n is an integer between 1 and 4 (i.e., 1≦n≦4). If n>4, it is easy to cause the viscosity of the dicyano ester compounds to increase, and to cause the electrical conductivity of the electrolyte solution to decrease, such that the high temperature storage performance of a lithium ion secondary battery deteriorates. Due to steric hindrance of the functional groups, at the same time, the surface reactivity decreases, leading to the weakened improvement effect thereof on the high temperature storage performance of a lithium ion secondary battery.

The molecular structure of a dicyano ester compound of a structure shown by Formula I, Formula II, or Formula III contains a symmetric dicyano group, and such a symmetric dicyano group has relatively strong complexing action with transition metals. At the same time, carbonate ester, sulfite ester, and sulfate ester groups have better compatibility with nonaqueous organic solvents, which are primarily carbonate esters, thereby eliminating the problem of lithium salt precipitation caused by alkane compounds similar to dicyano compounds. At the same time, the central ester groups of this type of dicyano ester compounds can effectively participate in the film-forming reaction, and prevent reactions between the electrolyte solution and the negative plate (negative electrode/anode). Moreover, the functional groups in dicyano compounds can effectively suppress the dissolution of transition metals from the positive plate (positive electrode/cathode) and suppress the catalyzed decomposition of electrolyte solution ingredients on the surface of the positive plate, thereby improving the high temperature storage performance of a lithium ion secondary battery and reducing a consequent gas generation in the lithium ion secondary batteries.

In the electrolyte solution of a lithium ion secondary battery according to the first aspect of the present disclosure, the mass of the dicyano ester compound of a structure shown by Formula I, Formula II, or Formula III may be 1%˜8% of the total mass of the electrolyte solution of the lithium ion secondary battery. If the content is less than 1%, the improvement of high temperature storage performance is insignificant. If the content is greater than 8%, passivation will occur on the positive and negative electrodes, leading to increased internal resistance of the lithium ion secondary battery and decreased capacity of the lithium ion secondary battery.

In the electrolyte solution of a lithium ion secondary battery according to the first aspect of the present disclosure, to achieve relatively good high temperature performance and have relatively high capacity of the lithium ion secondary battery, the mass of the dicyano ester compound of a structure shown by Formula I, Formula II, or Formula III may preferably be 3%˜5% of the total mass of the electrolyte solution of a lithium ion secondary battery.

In the electrolyte solution of a lithium ion secondary battery according to the first aspect of the present disclosure, the nonaqueous organic solvent may further include one or more selected from ethylene carbonate (EC), propylene carbonate (PC), dimethyl carbonate (DMC), diethyl carbonate (DEC), dipropyl carbonate (DPC), ethyl methyl carbonate (EMC), methyl propyl carbonate (EPC), vinylene carbonate (VC), fluoroethylene carbonate (FEC), 1,3-propane sultone (PS), and ethylene sulfate (ES).

In the electrolyte solution of a lithium ion secondary battery according to the first aspect of the present disclosure, when the nonaqueous organic solvent further includes PS, the mass of PS may be less than 5% of the total mass of the electrolyte solution of the lithium ion secondary battery.

In the electrolyte solution of a lithium ion secondary battery according to the first aspect of the present disclosure, the lithium salt may be one or more selected from LiPF₆ (lithium hexafluorophosphate), LiBF₄ (lithium tetrafluoroborate), LiBOB (lithium bis(oxatlato)borate), LiClO₄ (lithium perchlorate), LiAsF₆ (lithium hexafluoroarsenate), LiCF₃SO₃ (lithium trifluoromethanesulfonate), and Li(CF₃SO₂)₂N (lithium bis(trifluoromethanesulfonyl) imide).

Next, the lithium ion secondary battery according to the second aspect of the present disclosure will be described.

The lithium ion secondary battery according to the second aspect of the present disclosure includes a positive plate, a negative plate, an isolating film disposed between the positive plate and the negative plate, and an electrolyte solution. The electrolyte solution is the electrolyte solution of the lithium ion secondary battery according to the first aspect of the present disclosure.

In the lithium ion secondary battery according to the second aspect of the present disclosure, the positive plate may include a material that can release and receive lithium ions.

In the lithium ion secondary battery according to the second aspect of the present disclosure, the material that can release and receive lithium ions may be a lithium-transition metal complex oxide.

In the lithium ion secondary battery according to the second aspect of the present disclosure, the lithium-transition metal complex oxide may be one or more selected from lithium-transition metal oxides, and compounds obtained by adding other transition metals or non-transition metals into lithium-transition metal oxides.

In the lithium ion secondary battery according to the second aspect of the present disclosure, the lithium-transition metal oxides may be one or more selected from lithium cobalt oxides, lithium nickel oxides, lithium manganese oxides, lithium nickel manganese oxides, lithium nickel cobalt manganese oxides, and lithium nickel cobalt aluminum oxides. The dicyano ester compounds of a structure shown by Formula I, Formula II, or Formula III according to the present disclosure have relatively strong complexing action with transition metals (e.g., lithium cobalt oxides, lithium nickel cobalt manganese oxides, etc.), and can achieve significant protective effects.

In the lithium ion secondary battery according to the second aspect of the present disclosure, the working voltage of the lithium ion secondary battery may be 4.3 V or higher.

Next, examples and comparison examples of the lithium ion secondary battery and electrolyte solution thereof according to the second aspect of the present disclosure will be described.

### COMPARISON EXAMPLE 1

(1) Preparation of Electrolyte Solution

Mix EC and DEC at a mass ratio of 40:60, and dissolve a lithium salt of 1 M LiPF₆ as the electrolyte solution of the lithium ion secondary battery.

(2) Preparation of a Lithium Ion Secondary Battery

Thoroughly mix LiNi_{0.5}Co_{0.2}Mn_{0.3}O₂(LNCM) as the positive electrode active material, acetylene black as the conductive agent, and polyvinylidene fluoride (PVDF) as the binding agent at a mass ratio of 96:2:2 in a solvent, N-methylpyrrolidone, stir homogeneously, coat on a current collector Al foil, dry and cold press, and obtain the positive plate of the lithium ion secondary battery.

Thoroughly mix graphite as the active material, acetylene black as the conductive agent, styrene-butadiene rubber (SBR) as the binding agent, and sodium carboxymethyl cellulose (CMC) as the thickening agent at a mass ratio of 96:2:2 in deionized water as the solvent, stir homogeneously, coat on a current collector copper (Cu) foil, dry and cold press, and obtain the negative plate of the lithium ion secondary battery.

Sequentially stack the prepared positive plate, polyethylene (PE) porous polymer film as the isolating film, and negative plate such that the isolating film is disposed between the positive plate and the negative plate for isolation, wind to obtain a naked battery core, place the naked battery core into an external package, inject the prepared electrolyte solution and encapsulate to obtain the lithium ion secondary battery.

### COMPARISON EXAMPLE 2

Prepare an electrolyte solution and a lithium ion secondary battery using the same method as the one in Comparison Example 1. The difference is that in the preparation of the electrolyte solution (i.e., step (1)), EC, PS, and DEC are mixed at a mass ratio of 40:3:57, and a lithium salt of 1 M LiPF₆ is dissolved as the electrolyte solution of the lithium ion secondary battery.

### COMPARISON EXAMPLE 3

Prepare an electrolyte solution and a lithium ion secondary battery using the same method as the one in Comparison Example 2. The difference is that in the preparation of the electrolyte solution (i.e., step (1)), methyl propionitrile carbonate is further added into the electrolyte solution at 3% of the total mass of the electrolyte solution of a lithium ion secondary battery.

### COMPARISON EXAMPLE 4

Prepare an electrolyte solution and a lithium ion secondary battery using the same method as the one in Comparison Example 1. The difference is that in the preparation of the electrolyte solution (i.e., step (1)), EC, VC, and DEC are mixed at a mass ratio of 40:1:59, and a lithium salt of 1 M LiPF₆ is dissolved as the electrolyte solution of the lithium ion secondary battery.

### EXAMPLE 1

Prepare an electrolyte solution and a lithium ion secondary battery using the same method as the one in Comparison Example 2. The difference is that in the preparation of the electrolyte solution (i.e., step (1)), dipropionitrile carbonate is further added into the electrolyte solution at 3% of the total mass of the electrolyte solution of a lithium ion secondary battery.

### EXAMPLE 2

Prepare an electrolyte solution and a lithium ion secondary battery using the same method as the one in Comparison Example 2. The difference is that in the preparation of the electrolyte solution (i.e., step (1)), dipropionitrile sulfite is further added into the electrolyte solution at 3% of the total mass of the electrolyte solution of a lithium ion secondary battery.

### EXAMPLE 3

Prepare an electrolyte solution and a lithium ion secondary battery using the same method as the one in Comparison Example 2. The difference is that in the preparation of the electrolyte solution (i.e., step (1)), dipropionitrile sulfate is further added into the electrolyte solution at 3% of the total mass of the electrolyte solution of a lithium ion secondary battery.

### EXAMPLE 4

Prepare an electrolyte solution and a lithium ion secondary battery using the same method as the one in Comparison Example 2. The difference is that in the preparation of the electrolyte solution (i.e., step (1)), dipropionitrile carbonate is further added into the electrolyte solution at 1% of the total mass of the electrolyte solution of a lithium ion secondary battery.

### EXAMPLE 5

Prepare an electrolyte solution and a lithium ion secondary battery using the same method as the one in Comparison Example 2. The difference is that in the preparation of the electrolyte solution (i.e., step (1)), dipropionitrile carbonate is further added into the electrolyte solution at 5% of the total mass of the electrolyte solution of the lithium ion secondary battery.

### EXAMPLE 6

Prepare an electrolyte solution and a lithium ion secondary battery using the same method as the one in Comparison Example 2. The difference is that in the preparation of the electrolyte solution (i.e., step (1)), dipropionitrile carbonate is further added into the electrolyte solution at 8% of the total mass of the electrolyte solution of the lithium ion secondary battery.

### EXAMPLE 7

Prepare an electrolyte solution and a lithium ion secondary battery using the same method as the one in Comparison Example 1. The difference is that in the preparation of the electrolyte solution (i.e., step (1)), EC, PS, and DEC are mixed at a mass ratio of 40:1:59, a lithium salt of 1 M LiPF₆ is dissolved, and additionally dipropionitrile sulfate is further added at 5% of the total mass of the electrolyte solution of a lithium ion secondary battery, which is used as the electrolyte solution of the lithium ion secondary battery.

### EXAMPLE 8

Prepare an electrolyte solution and a lithium ion secondary battery using the same method as the one in Comparison Example 1. The difference is that in the preparation of electrolyte solution (i.e., step (1)), EC, PS, and DEC are mixed at a mass ratio of 40:5:55, a lithium salt of 1 M LiPF₆ is dissolved, and additionally dipropionitrile sulfate is further added at 1% of the total mass of the electrolyte solution of a lithium ion secondary battery, which is used as the electrolyte solution of the lithium ion secondary battery.

### EXAMPLE 9

Prepare an electrolyte solution and a lithium ion secondary battery using the same method as the one in Comparison Example 2. The difference is that in the preparation of the electrolyte solution (i.e., step (1)), dibutyronitrile carbonate is further added into the electrolyte solution at 3% of the total mass of the electrolyte solution of a lithium ion secondary battery.

### EXAMPLE 10

Prepare an electrolyte solution and a lithium ion secondary battery using the same method as the one in Comparison Example 2. The difference is that in the preparation of the electrolyte solution (i.e., step (1)), divaleronitrile carbonate is further added into the electrolyte solution at 3% of the total mass of the electrolyte solution of a lithium ion secondary battery.

### EXAMPLE 11

Prepare an electrolyte solution and a lithium ion secondary battery using the same method as the one in Comparison Example 1. The difference is that in the preparation of electrolyte solution (i.e., step (1)), EC, VC, PS, and DEC are mixed at a mass ratio of 40:1:3:56, a lithium salt of 1 M LiPF₆ is dissolved, and additionally dipropionitrile carbonate is further added at 4% of the total mass of the electrolyte solution of a lithium ion secondary battery, which is used as the electrolyte solution of the lithium ion secondary battery.

### EXAMPLE 12

Prepare an electrolyte solution and a lithium ion secondary battery using the same method as the one in Comparison Example 1. The difference is that in the preparation of electrolyte solution (i.e., step (1)), EC, VC, PS, and DEC are mixed at a mass ratio of 40:1:3:56, a lithium salt of 1 M LiPF₆ is dissolved, and additionally dipropionitrile sulfate is further added at 4% of the total mass of the electrolyte solution of a lithium ion secondary battery, which is used as the electrolyte solution of the lithium ion secondary battery.

Lastly, the testing process and testing results of the lithium ion secondary battery according to the present disclosure will be described.

High Temperature Storage Performance Testing

Take 3 lithium ion secondary batteries from each of Comparison Examples 1 to 4 and Examples 1 to 12, charge at normal temperature and at a constant current charge rate (also referred to as C-rate) of 0.5 C until the voltage is above 4.35 V, further charge at a constant voltage of 4.35 V until the charge rate is below 0.05 C, such that it is in the 4.35 V fully charged state, test the thickness of the fully charged lithium ion secondary batteries prior to storage, and record as D₀. Then, place the fully charged lithium ion secondary batteries in a 60° C. oven. After 25 days, take out the lithium ion secondary batteries, immediately test the thickness after storage, and record as D₁. Calculate the rate of thickness expansion of the lithium ion secondary batteries before and after the storage according to the following equation: ε=(D₁−D₀)/D₀×100%.

Table 1 lists relevant parameters and performance testing results of the lithium ion secondary batteries from Comparison Examples 1 to 4 and Examples 1 to 12.

It can be seen from Table 1 that the addition of a dicyano ester compound into the electrolyte solution at 1%˜8% of the total mass of the electrolyte solution of a lithium ion secondary battery can effectively lower the rate of thickness expansion of the lithium ion secondary batteries and improve the high temperature storage performance of the lithium ion secondary batteries.

It can be seen from the comparison of Comparison Examples 1 to 4 and Examples 1 to 3 that VC alone (Comparison Example 4) does not significantly improve the high temperature storage performance of the lithium ion secondary battery; while PS alone (Comparison Example 2) can significantly improve the high temperature storage performance of the lithium ion secondary battery; the further addition of asymmetric methyl propionitrile carbonate together with PS (Comparison Example 3) does not further improve the high temperature storage performance of the lithium ion secondary battery; while the further addition of dicyano ester compounds together with PS (Examples 1 to 3) significantly further improves the high temperature storage performance of the lithium ion secondary battery. This further demonstrates that only symmetric dicyano ester compounds can have complexing action with transition metals. Among those, dicyano carbonates and dicyano sulfates have achieved the best improvement, which is probably related to their relatively high reduction potential.

It can be seen from the comparison of Examples 3, 7, and 8 that as the mass percent of PS increases, the rate of thickness expansion of the lithium ion secondary batteries decreases first and then increases, which may probably be related to the film-forming effect under the coordinated action of dicyano ester compounds with different solubilities and PS. It can be seen from the comparison of Examples 1, 4, 5, and 6 that as the mass percent of dicyano carbonate increases, the rate of thickness expansion of the lithium ion secondary batteries decreases first and then increases, indicating that if the mass percent of dicyano carbonate is too low, the improvement of the high temperature storage performance of the lithium ion secondary battery is not significant, if the mass percent is too high, passivation will occur on the positive and negative electrodes, leading to increased internal resistance of the lithium ion secondary batteries and decreased capacity of the lithium ion secondary batteries. When the mass percent of dicyano ester compounds is 3%˜5% of the total mass of the electrolyte solution of a lithium ion secondary battery, therefore, the lithium ion secondary batteries can have relatively good high temperature storage performance and relatively high capacities at the same time.

It can be seen from the comparison of Examples 1, 9, and 10 that as n increases, the rate of thickness expansion of the lithium ion secondary batteries increases, indicating that n should not be too high. When n is too high, it is easy to cause the viscosity of the dicyano ester compounds to increase, and to cause the electrical conductivity of the electrolyte solution to decrease, such that the high temperature storage performance of a lithium ion secondary battery deteriorates; due to steric hindrance of the functional groups, at the same time, the surface reactivity decreases, leading to the weakened improvement effect thereof on the high temperature storage performance of a lithium ion secondary battery.

It can be seen from the comparison of Comparison Examples 4, 11, and 12 that although VC alone (Comparison Example 4) does not significantly improve the high temperature storage performance of the lithium ion secondary battery, its cooperation with PS and dicyano ester compounds can further improve the high temperature storage performance of the lithium ion secondary battery. A probable reason is that central groups of carbonate esters and sulfate esters in dicyano ester compounds undergo oxidation-reduction reactions to form a dense film on the surface of the electrode plates, which prevents the reaction between the electrode plates and the electrolyte solution, and effectively reduces the capability of high-valent metal ions to oxidize the electrolyte solution; at the same time, the dicyano group has a very strong complexing action with high-valent metal ions on the surface of the positive plate, which further reduces the reaction of transition metal ions with the electrolyte solution, thereby improving high temperature storage performance of the lithium ion secondary battery.

Table 1 follows:

TABLE 1
Relevant parameters and performance testing results of Comparison Examples 1-4 and
Examples 1-12

| | | | | | Lithium ion |
|---|---|---|---|---|---|
| | | | | | secondary |
| | Electrolyte solution of a lithium ion secondary battery | | | | battery |
| | Lithium | Nonaqueous organic solvent | | | Rate of |
| | salt | | dicyano ester | | thickness |
| | solubility | mass ratio | compound | mass percent | expansion |
| Comparison | LiPF₆ | EC:DEC | / | / | 89% |
| Example 1 | 1M | 40:60 | | | |
| Comparison | LiPF₆ | EC:PS:DEC | / | / | 42% |
| Example 2 | 1M | 40:3:57 | | | |
| Comparison | LiPF₆ | EC:PS:DEC | methyl propionitrile | 3% | 40% |
| Example 3 | 1M | 40:3:57 | carbonate | | |
| Comparison | LiPF₆ | EC:VC:DEC | / | / | 92% |
| Example 4 | 1M | 40:1:59 | | | |
| Example 1 | LiPF₆ | EC:PS:DEC | dipropionitrile | 3% | 13% |
| | 1M | 40:3:57 | carbonate | | |
| Example 2 | LiPF₆ | EC:PS:DEC | dipropionitrile | 3% | 21% |
| | 1M | 40:3:57 | sulfite | | |
| Example 3 | LiPF₆ | EC:PS:DEC | dipropionitrile | 3% | 11% |
| | 1M | 40:3:57 | sulfate | | |
| Example 4 | LiPF₆ | EC:PS:DEC | dipropionitrile | 1% | 29% |
| | 1M | 40:3:57 | carbonate | | |
| Example 5 | LiPF₆ | EC:PS:DEC | dipropionitrile | 5% | 12% |
| | 1M | 40:3:57 | carbonate | | |
| Example 6 | LiPF₆ | EC:PS:DEC | dipropionitrile | 8% | 20% |
| | 1M | 40:3:57 | carbonate | | |
| Example 7 | LiPF₆ | EC:PS:DEC | dipropionitrile | 5% | 15% |
| | 1M | 40:1:59 | sulfate | | |
| Example 8 | LiPF₆ | EC:PS:DEC | dipropionitrile | 1% | 13% |
| | 1M | 40:5:55 | sulfate | | |
| Example 9 | LiPF₆ | EC:PS:DEC | dibutyronitrile | 3% | 27% |
| | 1M | 40:3:57 | carbonate | | |
| Example 10 | LiPF₆ | EC:PS:DEC | divaleronitrile | 3% | 32% |
| | 1M | 40:3:57 | carbonate | | |
| Example 11 | LiPF₆ | EC:VC:PS:DEC | dipropionitrile | 4% | 10% |
| | 1M | 40:1:3:56 | carbonate | | |
| Example 12 | LiPF₆ | EC:VC:PS:DEC | dipropionitrile | 4% | 9% |
| | 1M | 40:1:3:56 | sulfate | | |

What is claimed is:

1. An electrolyte solution of a lithium ion secondary battery, comprising:
a nonaqueous organic solvent; and
a lithium salt dissolved in the nonaqueous organic solvent,
wherein the nonaqueous organic solvent comprises a dicyano ester compound of a structure shown by Formula I, Formula II, or Formula III, 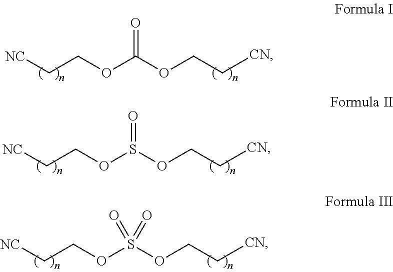
wherein Formula I represents dicyano carbonate ester compounds, Formula II represents dicyano sulfite ester compounds, Formula III represents dicyano sulfate ester compounds, and n is an integer greater than or equal to 1 and less than or equal to 4.

2. The electrolyte solution of the lithium ion secondary battery of claim 1, wherein the mass of said dicyano ester compound of a structure shown by Formula I, Formula II, or Formula III is 1% to 8% of the total mass of the electrolyte solution of the lithium ion secondary battery.

3. The electrolyte solution of the lithium ion secondary battery of claim 2, wherein the mass of said dicyano ester compound of a structure shown by Formula I, Formula II, or Formula III is 3% to 5% of the total mass of the electrolyte solution of the lithium ion secondary battery.

4. The electrolyte solution of the lithium ion secondary battery of claim 1, wherein said nonaqueous organic solvent further comprises one or more selected from ethylene carbonate (EC), propylene carbonate (PC), dimethyl carbonate (DMC), diethyl carbonate (DEC), dipropyl carbonate (DPC), ethyl methyl carbonate (EMC), methyl propyl carbonate (EPC), vinylene carbonate (VC), fluoroethylene carbonate (FEC), 1,3-propane sultone (PS), and ethylene sulfate (ES).

5. The electrolyte solution of the lithium ion secondary battery of claim 4, wherein said nonaqueous organic solvent further comprises PS, and the mass of the PS is less than 5% of the total mass of the electrolyte solution of the lithium ion secondary battery.

6. The electrolyte solution of the lithium ion secondary battery of claim 1, wherein said lithium salt is one or more selected from LiPF₆, LiBF₄, LiBOB, LiClO₄, LiAsF₆, LiCF₃SO₃, and Li(CF₃SO₂)₂N.

7. A lithium ion secondary battery, comprising:
a positive plate;
a negative plate;
an isolating film disposed between the positive plate and the negative plate; and
an electrolyte solution,
wherein said electrolyte solution comprises:
a nonaqueous organic solvent; and
a lithium salt dissolved in the nonaqueous organic solvent,
wherein the nonaqueous organic solvent comprises a dicyano ester compound of a structure shown by Formula I, Formula II, or Formula III, 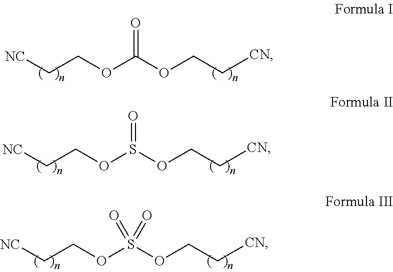
wherein Formula I represents dicyano carbonate ester compounds, Formula II represents dicyano sulfite ester compounds, Formula III represents dicyano sulfate ester compounds, and n is an integer greater than or equal to 1 and less than or equal to 4.

8. The lithium ion secondary battery of claim 7, wherein the mass of said dicyano ester compound of a structure shown by Formula I, Formula II, or Formula III is 1% to 8% of the total mass of the electrolyte solution of the lithium ion secondary battery.

9. The lithium ion secondary battery of claim 8, wherein the mass of said dicyano ester compound of a structure shown by Formula I, Formula II, or Formula III is 3% to 5% of the total mass of the electrolyte solution of the lithium ion secondary battery.

10. The lithium ion secondary battery of claim 7, wherein said nonaqueous organic solvent further comprises one or more selected from ethylene carbonate (EC), propylene carbonate (PC), dimethyl carbonate (DMC), diethyl carbonate (DEC), dipropyl carbonate (DPC), ethyl methyl carbonate (EMC), methyl propyl carbonate (EPC), vinylene carbonate (VC), fluoroethylene carbonate (FEC), 1,3-propane sultone (PS), and ethylene sulfate (ES).

11. The lithium ion secondary battery of claim 10, wherein said nonaqueous organic solvent further comprises PS, and the mass of the PS is less than 5% of the total mass of the electrolyte solution of the lithium ion secondary battery.

12. The lithium ion secondary battery of claim 7, wherein said lithium salt is one or more selected from LiPF₆, LiBF₄, LiBOB, LiClO₄, LiAsF₆, LiCF₃SO₃, and Li(CF₃SO₂)₂N.

13. The lithium ion secondary battery of claim 7, wherein said positive plate comprises a material that can release and receive lithium ions, said material that can release and receive lithium ions is a lithium-transition metal complex oxide, and said lithium-transition metal complex oxide is one or more selected from lithium-transition metal oxides, and compounds obtained by adding other transition metals or non-transition metals into lithium-transition metal oxides.

14. The lithium ion secondary battery of claim 13, wherein said lithium-transition metal oxides is one or more selected from lithium cobalt oxides, lithium nickel oxides, lithium manganese oxides, lithium nickel manganese oxides, lithium nickel cobalt manganese oxides, and lithium nickel cobalt aluminum oxides.

15. The lithium ion secondary battery of claim 7, wherein the working voltage of the lithium ion secondary battery is 4.3 V or higher.
